(19) United States
(12) Patent Application Publication
(10) Pub. No.: US 2018/0148024 A1
(43) Pub. Date: May 31, 2018

(54) APPARATUS AND METHOD FOR DETERMINING LOAD WEIGHT

(71) Applicant: Bendix Commercial Vehicle Systems LLC, Elyria, OH (US)

(72) Inventors: Joseph M. Macnamara, Ashland, OH (US); Jon D. Intagliata, Avon, OH (US)

(21) Appl. No.: 15/361,697

(22) Filed: Nov. 28, 2016

(51) Int. Cl. B60T 8/1755; B60T 8/18; B60T 8/17; B60T 8/24; B60G 17/015

(52) U.S. Cl. CPC B60T 8/1755; B60T 8/1887; B60T 8/1708; B60G 2400/60; B60G 17/0155; B60G 2400/252; B60T 8/243

(57) ABSTRACT

A controller determines a load weight associated with a plurality of pneumatically independent circuits of a vehicle suspension system. The controller is adapted to receive an electronic pressure signal, at a controller electronic input port, based on a single pneumatic signal representative of respective pneumatic pressures in the plurality of pneumatically independent circuits. The controller is also adapted to determine the load weight based on the electronic pressure signal and control an operation of a function of an associated vehicle based on the load weight.

### BACKGROUND

The present invention relates to determining a load weight of a vehicle. It finds particular application in conjunction with independent pneumatic circuits and will be described with particular reference thereto. It will be appreciated, however, that the invention is also amenable to other applications.

A typical Trailer Roll Stability Program (TRSP) measures air pressure on an air suspension and converts the pressure reading to a load percentage, and even to an interpreted weight, based on a single pressure input, which is either integrated via a port on the TRSP valve or with an external electrically connected pressure sensor. Since air-bags in an air suspension are typically all pneumatically connected, the air pressure in any one air bag is representative of the pressure of the entire air bag circuit. The leveling or height control valve allows air in or out of the air suspension circuit based on the load placed on the suspension. A height control valve activates based on both vehicle empty sprung weight and payload added or removed to/from the vehicle. The pressure in any one air bag typically does not vary much from any other air bag in the system, which comes to equilibrium within a relatively short amount of time. The air bags along with electronic filtering act to give a stable signal from a pressure measurement perspective. From a TRSP perspective a single measurement is adequate to interpret the load on the trailer.

Some air suspension systems have multiple independently controlled pneumatic circuits that don't equilibrate to a single pressure. One example of such an independently controlled pneumatic system is a dual-circuit pneumatic system having independent circuits on respective sides of a vehicle. Other examples of such systems have independently controlled pneumatic circuits for respective vehicle axles or even individual air bags.

From a TRSP perspective, since pneumatic pressure in one of the circuits may not match the pneumatic pressure(s) in the other circuit(s), multi-circuit pneumatic circuits for air bag suspension control systems may be problematic. More specifically, there is not a single pneumatic pressure on which the load percentage or interpreted weight may be based.

The present invention provides a new and improved apparatus and method for determining a load weight.

### SUMMARY

In one aspect of the present invention, it is contemplated that a controller determines a load weight associated with a plurality of pneumatically independent circuits of a vehicle suspension system. The controller is adapted to receive an electronic pressure signal, at a controller electronic input port, based on a single pneumatic signal representative of respective pneumatic pressures in the plurality of pneumatically independent circuits. The controller is also adapted to determine the load weight based on the electronic pressure signal and control an operation of a function of an associated vehicle based on the load weight.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of an exemplary system for determining a load weight associated with a plurality of pneumatically independent circuits of a vehicle suspension system in accordance with one embodiment of an apparatus illustrating principles of the present invention; and

FIG. 2 is an exemplary methodology of determining a load weight in accordance with one embodiment illustrating principles of the present invention.

### DETAILED DESCRIPTION OF ILLUSTRATED EMBODIMENT

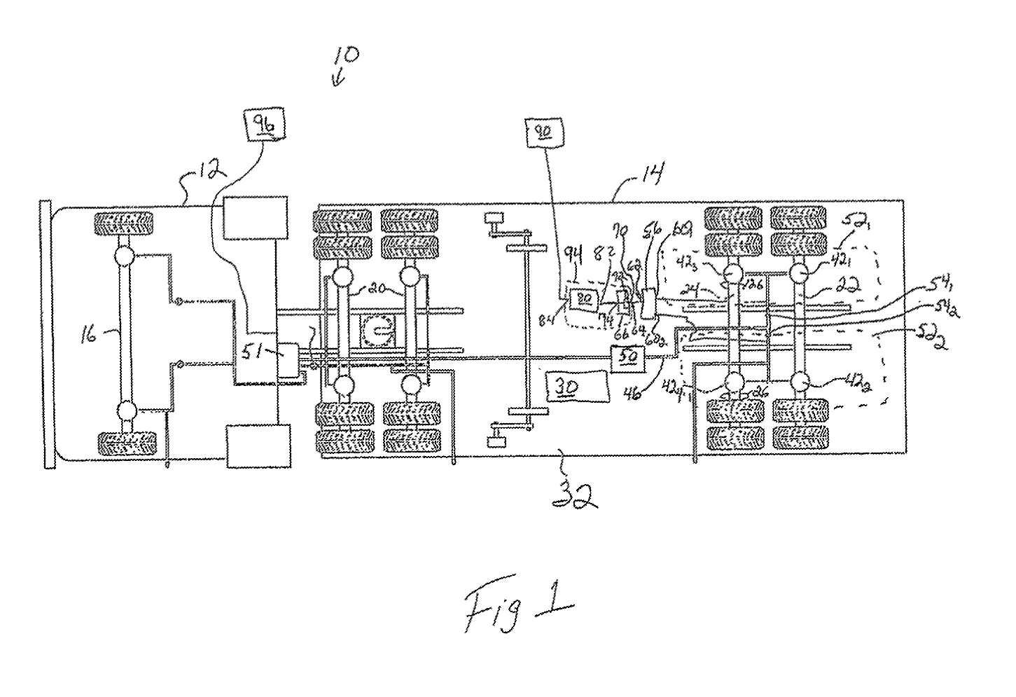

With reference to FIG. 1, a schematic representation of an exemplary system for determining a load weight associated with a plurality of pneumatically independent circuits of a vehicle suspension system is illustrated in accordance with one embodiment of the present invention. A vehicle 10 includes a towing portion 12 (e.g., a tractor) and a towed portion 14 (e.g., a trailer).

The tractor 12 is removably coupled to the trailer 14. The tractor 12 includes a tractor steer axle 16 and a tractor drive axle 20. In the illustrated embodiment, two (2) rear axles collectively comprise the tractor drive axle 20.

The trailer 14 includes a trailer stationary axle 22 and a trailer lift axle 24. Although only one (1) trailer stationary axle 22 is shown in the illustrated embodiment, it is to be understood that other arrangements including other numbers of axles or groups of axles are contemplated in other embodiments.

At least one lift air bag 26 (e.g., bellow) is deflated/inflated to set a position (e.g., a height) of the trailer lift axle 24 based on, for example, a weight of a load 30 (e.g., a load weight) on a bed 32 of the trailer 14. Although, for purposes of illustration, the load 30 is only illustrated as a small package on one side of the trailer bed 32, it is to be understood that the load 30 may be any size and on one side, the other side, or both sides (either evenly or unevenly) of the trailer bed 32. In one example, the height of the trailer lift axle 24 moves between a maximum height (e.g., fully retracted) position and a minimum height (e.g., fully extended) position. The trailer lift axle 24 is biased by a spring, for example, to the maximum height. Therefore, to set the height of the trailer lift axle 24 to the maximum height (e.g., fully retracted) position, the at least one lift bag 26 is substantially fully inflated. Conversely, to set the height of the trailer lift axle 24 to the minimum height (e.g., fully extended) position, the at least one lift bag 26 is substantially fully deflated to overcome the bias of the spring associated with the trailer lift axle 24. In the fully retracted position, the height is the distance (e.g., six (6) inches) between a surface of the road on which the vehicle 10 is traveling and a tire associated with the trailer lift axle 24 when the at least one lift bag 26 is substantially fully inflated. In the fully extended position, the height is zero (0) feet off of the road surface (since the tire associated with the trailer lift axle 24 is travelling on the road surface). It is to be understood that any height of the trailer lift axle 24 between the maximum height and the minimum height is achieved by partially deflating/inflating the at least one lift bag 26.

The trailer 14 includes an air-ride suspension that includes at least two (e.g., four (4)) suspension air bags 42₁, 42₂, 42₃, 42₄ (collectively 42). The suspension air bags 42 are supplied with air through a pneumatic line 46 (e.g., air line), which extends from an air reservoir 50 (e.g., tank) mounted to the trailer 14. It is to be understood the tank 50 receives pneumatic fluid from a source on the tractor 12 (e.g., a reservoir 51). The air-ride suspension typically includes an air leveler, which is known in the art.

When the trailer lift axle 24 is at the minimum height (e.g., fully extended), the suspension air bags 42₁, 42₃ fluidly communicate with each other and are part of a first pneumatic circuit 52₁. The suspension air bags 42₂, 42₄ fluidly communicate with each other and are part of a second pneumatic circuit 52₂. The first and second pneumatic circuits 52₁, 52₂ (collectively 52) are fluidly independent (e.g., isolated) from each other. Therefore, although the suspension air bags 42 are supplied with air through the pneumatic line 46, first and second height control valves 54₁, 54₂ (collectively 54) fluidly isolates the suspension air bags 42₁, 42₃ from the suspension air bags 42₂, 42₄, thereby creating the respective independent (e.g., isolated) pneumatic circuits 52₁, 52₂.

When the trailer lift axle 24 is at the maximum height (e.g., fully retracted), the first pneumatic circuit 52₁ only includes the suspension air bag 42₁ and the second pneumatic circuit 52₂ only includes the suspension air bag 42₂. For purposes of the below discussion, it is assumed that the trailer lift axle 24 is at the minimum height (e.g., fully extended) so that the first pneumatic circuit 52₁ includes both the suspension air bag 42₁, 42₃ and the second pneumatic circuit 52₂ includes both the suspension air bag 42₂, 42₄.

A sensor valve 56 includes independent (e.g., isolated) pneumatic inputs 60₁, 60₂ (collectively 60) that fluidly communicate with the respective pneumatic circuits 52₁, 52₂ and a pneumatic output 62. It is to be understood that although only two (2) independent pneumatic circuits 52 are illustrated, any number of independent pneumatic circuits greater than two (2) are also contemplated. In addition, although each of the two (2) independent pneumatic circuits 52 are illustrated as including two (2) suspension air bags, it is to be understood that either of the independent pneumatic circuits 52 may include one (1) or more suspension air bags. In addition, although each of the two (2) independent pneumatic circuits 52 are illustrated as including the same number of suspension air bags, it is contemplated that independent pneumatic circuits may include different numbers of suspension air bags.

In one embodiment, the sensor valve 56 is set to pass the highest pressure of the respective independent pneumatic circuits 52 from the pneumatic inputs 60 to the pneumatic output 62. In another embodiment, the sensor valve 56 is set to pass the lowest pressure of the respective independent pneumatic circuits 52 from the pneumatic inputs 60 to the pneumatic output 62. In yet another embodiment, the sensor valve 56 is set to pass the average pressure of the respective independent pneumatic circuits 52 from the pneumatic inputs 60 to the pneumatic output 62. It is contemplated that the sensor valve 56 is previously set and/or “hardwired” at the time of manufacture, for example, to pass the highest, lowest, or average pressure from the pneumatic inputs 60 to the pneumatic output 62. However, other embodiments are also contemplated in which the sensor valve 56 may be set “on the fly” to pass the highest, lowest, or average pressure from the pneumatic inputs 60 to the pneumatic output 62.

The respective pressures in the pneumatic circuits 52 and the single pressure at the pneumatic output 62 are based on and represent the weight of the load 30 (i.e., the load weight) on the bed 32 of the trailer 14. Therefore, the pressure at the pneumatic output 62 is a single pneumatic signal representative of the respective pressures in the pneumatic circuits 52 and the weight of the load 30 on the bed 32 of the trailer 14.

The pneumatic output 62 of the sensor valve 56 fluidly communicates with a pneumatic input 64 of a brake valve 66. A pneumatic input 70 of a pneumatic to electrical converter 72 fluidly communicates with and senses the pneumatic pressure received at the pneumatic input 64 of the brake valve 66. The converter 72 converts the sensed pneumatic pressure to an electrical signal and transmits the electrical signal, which is based on and represents the sensed pneumatic pressure, from an electrical output 74.

An electronic control unit (ECU) 80 (e.g., a controller) electrically communicates with the electrical output 74 of the converter 72 and is adapted to receive the electrical signal, at an ECU electrical input 82, that is based on and represents the sensed pneumatic pressure in the pneumatic output 62 of the sensor valve 56 and the pneumatic input 64 of the brake valve 66. Therefore, the electrical signal received by at the ECU electrical input 82 is based on a single pneumatic signal representative of the respective pneumatic pressures in the plurality of pneumatically independent circuits 52.

Since the single pneumatic signal is representative of the load weight, the controller determines the load weight based on the electrical signal that is representative of the single pneumatic signal. In one embodiment, the load weight is linearly related to the single pneumatic signal. Therefore, the load weight is determined as:

y=mx+b, where
y=Load Weight (pounds);
x=Pneumatic Pressure represented by the electrical signal (pounds per square inch (psi));
m=Slope; and
b=Constant based on the weight of the trailer axles when the air bag pressure is at zero (0).

In one embodiment, the slope (m) is provided by the manufacturer of the suspension with the air bags 42 on the vehicle trailer 14. For purposes of discussion, the slope (m) is assumed to be a constant.

An operation of a function of the vehicle 10 is controlled based on the load weight (y). It is contemplated that the vehicle function is at least one of a roll stability function (e.g., a trailer roll stability function), an antilock braking function, a lift axle control function, etc. If the function is the roll stability function, the controller 80 is adapted to control the operation of the roll stability function by setting a threshold of a parameter, based on the load weight, at which an automated braking associated with the roll stability function occurs.

In one embodiment, the parameter is a lateral acceleration of the vehicle 10. In this case, the controller 80 is adapted to control the operation of the roll stability function by decreasing (e.g., linearly decreasing) the threshold of the lateral acceleration (e.g., the parameter) at which the automated braking occurs as the load weight increases. In other words, the automated braking is initiated with relatively lower lateral acceleration and, therefore, is said to be more sensitive to lateral acceleration of the vehicle 10. Conversely, the controller 80 is adapted to control the operation of the roll stability function by increasing (e.g., linearly increasing) the threshold of the lateral acceleration (e.g., the parameter) at which the automated braking occurs as the load weight decreases.

In one example, the controller 80 is adapted to linearly decrease the lateral acceleration threshold at which the automated braking occurs from about 4.0 m/s² at a load weight of about 20% of a maximum rated load weight of the vehicle 10 to about 2.5 m/s² at a load weight of about 80% of a maximum rated load weight of the vehicle 10.

The controller 80 is adapted to transmit an electrical load weight signal from an ECU electrical output 84. In one embodiment, the electrical load weight signal is transmitted to a device 90 for displaying and/or recording the load weight. For example, the electrical load weight signal may be transmitted to the device 90 electrically connected to the ECU electrical output 84. In another example, the electrical load weight signal may be transmitted as a power line carrier signal to a device 96 on the tractor 12. It is also contemplated that the electrical load weight signal may be wirelessly transmitted from the ECU 80, the device 90 and/or the device 96.

The controller 80 is also capable of receiving an electronic lift axle height signal at a controller input from the trailer lift axle 24. It is contemplated that the electronic lift axle height signal is received at the ECU electrical input 82 or a separate ECU electrical input. The lift axle height signal indicates a current height of the trailer lift axle 24.

The controller 80 determines a desired height of the trailer lift axle 24 based on the load weight. For example, if the load weight is at least a predetermined threshold, it is determined that the trailer lift axle 24 should be in the fully extended position. Or, if the load weight is not at least a predetermined threshold, it is determined that the trailer lift axle 24 should be in the fully retracted position.

If the lift axle height signal indicates the trailer lift axle 24 is not within a predetermined range (e.g., 6 inches) of the desired position, the controller 80 transmits a signal for setting the trailer lift axle 24 to within the predetermined range of the desired position. Although the trailer lift axle 24 is only described as being in the fully retracted or fully extended position, it is to be understood any height between these positions is also contemplated.

Although the brake valve 66 and the controller 80 are described as separate components, it is also contemplated that the brake valve 66 and the controller 80 are integrated into a combined brake valve and controller 94. The combined brake valve and controller 94 includes a brake valve portion (e.g., the brake valve 66) and a controller portion (e.g., the controller 80).

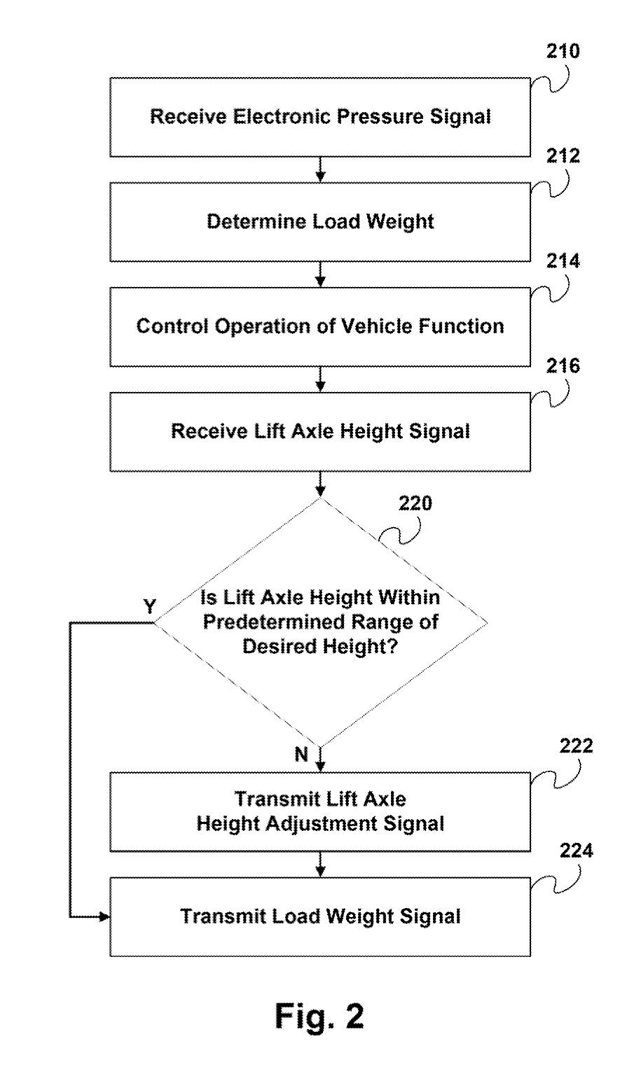

With reference to FIG. 2, an exemplary methodology of the system shown in FIG. 1 for determining a load weight is illustrated. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

With reference to FIGS. 1 and 2, the controller 80 receives the electronic pressure signal at the controller electronic input port 82 in a step 210. The controller 80 determines the load weight, as discussed above, in a step 212. The controller 80 controls the operation of the vehicle function (e.g., the roll stability function) in a step 214.

The controller 80 receives the lift axle height signal in a step 216. Then, the controller 80 determines if the lift axle height is within the predetermined range of the desired height in a step 220. If the lift axle height is not within the predetermined range of the desired height, the controller 80 transmits an electronic lift axle height adjustment signal, for setting the lift axle 24 to be within the predetermined range of the desired position, in a step 222. The controller 80 then transmits the electronic load weight signal as discussed above in a step 224.

Otherwise, if the lift axle height is within the predetermined range of the desired height, control passes directly from the step 220 to the step 224.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A controller for determining a load weight associated with a plurality of pneumatically independent circuits of a vehicle suspension system, the controller adapted to:
receive an electronic pressure signal, at a controller electronic input port, based on a single pneumatic signal representative of respective pneumatic pressures in the plurality of pneumatically independent circuits;
determine the load weight based on the electronic pressure signal; and
control an operation of a function of an associated vehicle based on the load weight.

2. The controller as set forth in claim 1, wherein:
the function is at least one of a roll stability function, an antilock braking function, and a lift axle function.

3. The controller as set forth in claim 1, wherein:
the function is a roll stability function; and
the controller is further adapted to control the operation of the roll stability function by setting a threshold of a parameter, based on the load weight, at which an automated braking associated with the roll stability function occurs.

4. The controller as set forth in claim 3, wherein the controller is further adapted to:
decrease the threshold of the parameter at which the automated braking occurs as the load weight increases.

5. The controller as set forth in claim 3, wherein:
the parameter is a lateral acceleration of the associated vehicle.

6. The controller as set forth in claim 4, wherein the controller is further adapted to:
linearly decrease the threshold of the parameter at which the automated braking occurs as the load weight increases.

7. The controller as set forth in claim 6, wherein the controller is further adapted to:
linearly decrease the lateral acceleration threshold at which the automated braking occurs from about 4.0 m/s² at a load weight of about 20% of a maximum rated load weight of the associated vehicle to about 2.5 m/s² at a load weight of about 80% of a maximum rated load weight of the associated vehicle.

8. The controller as set forth in claim 6, wherein:
the single pneumatic signal represents one of a highest, a lowest, and an average of the respective pneumatic pressures.

9. The controller as set forth in claim 1, wherein the controller is further adapted to:
transmit an electronic load weight signal, via a controller output port, based on the load weight.

10. The controller as set forth in claim 9, wherein the controller is further adapted to:
transmit the electronic load weight signal as a power line carrier signal from a trailer of the associated vehicle to a tractor of the associated vehicle.

11. The controller as set forth in claim 1, wherein the controller is further adapted to:
receive an electronic lift axle height signal at the controller electronic input port;
determine if the lift axle height is within a predetermined range of a desired height based on the load weight; and
if the lift axle height is not within a predetermined range of a desired height, transmit an electronic lift axle height adjustment signal, via a controller output, for setting the lift axle height to be within the predetermined range of the desired height.

12. The controller as set forth in claim 11, wherein the controller is further adapted to:
if the lift axle height is not within a predetermined range of a first desired height representing a fully extended lift axle height when the load weight is at least a predetermined threshold, transmit the electronic lift axle height adjustment signal for setting the lift axle height to be within the predetermined range of the fully extended lift axle height; and
if the lift axle height is not within a predetermined range of a second desired height representing a fully retracted lift axle height when the load weight is below the predetermined threshold, transmit the electronic lift axle height adjustment signal for setting the lift axle height to be within the predetermined range of the fully retracted lift axle height.

13. A combined brake valve and controller, the combined brake valve and controller comprising:
a brake valve portion, including:
a pneumatic input receiving a single pneumatic signal representative of respective pneumatic pressures in a plurality of pneumatically independent circuits supporting a load;
a pneumatic to electrical converter sensing a pressure of the single pneumatic signal and transmitting an electrical signal indicative of the pressure of the single pneumatic signal; and
a controller portion adapted to:
receive the electrical signal indicative of the pressure of the single pneumatic signal;
determine a weight of the load based on the electronic signal; and
control an operation of a function of an associated vehicle based on the load weight.

14. The combined brake valve and controller as set forth in claim 13, wherein:
the controller portion includes an electrical input that receives the electrical signal indicative of the pressure of the single pneumatic signal.

15. The combined brake valve and controller as set forth in claim 13, wherein:
the function of the associated vehicle is at least one of a roll stability function, an antilock braking function, and a lift axle function.

16. The combined brake valve and controller as set forth in claim 13, wherein:
the function of the associated vehicle is a roll stability function; and
the controller portion further adapted to:
control the operation of the roll stability function by setting a threshold of a parameter, based on the load weight, at which an automated braking associated with the roll stability function occurs.

17. The combined brake valve and controller as set forth in claim 16, wherein the controller is further adapted to:
decrease the threshold of the parameter at which the automated braking occurs as the load weight increases.

18. The combined brake valve and controller as set forth in claim 17, wherein:
the parameter is a lateral acceleration of the associated vehicle.

19. The combined brake valve and controller as set forth in claim 17, wherein the controller is further adapted to:
linearly increase the threshold of the parameter at which the automated braking occurs as the load weight decreases.

20. The combined brake valve and controller as set forth in claim 19, wherein the controller is further adapted to:
linearly increase the lateral acceleration threshold at which the automated braking occurs from about 2.5 m/s² at a load weight of about 80% of a maximum rated load weight of the associated vehicle to about 4.0 m/s² at a load weight of about 20% of a maximum rated load weight of the associated vehicle.

21. A method for determining a load weight associated with a plurality of pneumatically independent circuits of a vehicle suspension system, the method comprising:
receiving an electronic pressure signal based on a single pneumatic signal representative of respective pneumatic pressures in the plurality of pneumatically independent circuits;
determining the load weight based on the electronic pressure signal; and
controlling an operation of a function of an associated vehicle based on the load weight.

22. The method for determining a load weight as set forth in claim 21, wherein the controlling step includes:
controlling a roll stability function as the function of the associated vehicle; and
controlling the operation of the roll stability function by setting a threshold of a parameter, based on the load weight, at which an automated braking associated with the roll stability function occurs.

23. The method for determining a load weight as set forth in claim 22, further including:
decreasing the threshold of the parameter at which the automated braking occurs as the load weight increases.

24. The method for determining a load weight as set forth in claim 23, wherein the decreasing step includes:
decreasing the threshold of a lateral acceleration of the associated vehicle as the parameter at which the automated braking occurs as the load weight increases.

25. The method for determining a load weight as set forth in claim 24, wherein the decreasing step includes:
linearly decreasing the threshold of the parameter at which the automated braking occurs as the load weight increases.

26. The method for determining a load weight as set forth in claim 24, wherein the decreasing step includes:
linearly decreasing the lateral acceleration threshold at which the automated braking occurs from about 4.0 m/s² at a load weight of about 20% of a maximum rated load weight of the associated vehicle to about 2.5 m/s² at a load weight of about 80% of a maximum rated load weight of the associated vehicle.

27. The method for determining a load weight as set forth in claim 21, further including:
transmitting an electronic load weight signal based on the load weight.

28. The method for determining a load weight as set forth in claim 27, the transmitting step including:
transmitting the electronic load weight signal as a power line carrier signal from a trailer of the associated vehicle to a tractor of the associated vehicle.

29. The method for determining a load weight as set forth in claim 21, further including:
receiving an electronic lift axle height signal;
determining if the lift axle height is within a predetermined range of a desired position based on the load weight; and
if the lift axle height is not within a predetermined range of a desired position, transmitting an electronic lift axle height adjustment signal for setting the lift axle height to be within the predetermined range of the desired position.
